(19) United States
(12) Patent Application Publication
(10) Pub. No.: US 2021/0372347 A1
(43) Pub. Date: Dec. 2, 2021

(54) RADIAL SHAFT SEAL SHIPPING PROTECTOR SYSTEM

(71) Applicant: Freudenberg-NOK General Partnership, Plymouth, MI (US)

(72) Inventor: David BENNER, Clermont, GA (US)

(21) Appl. No.: 16/885,265

(22) Filed: May 28, 2020

(51) Int. Cl. F02F 11/00; F16J 15/08; B29C 65/48; B29C 65/00

(52) U.S. Cl. CPC F02F 11/00; F16J 15/0818; B29L 2031/748; B29C 66/7422; B29C 65/48

(57) ABSTRACT

An engine cover system, includes a metal engine cover having an opening that receives a radial shaft seal including a seal lip adapted to engage a shaft, and a plastic film adhered to the metal cover over top of the radial shaft seal.

### FIELD

The present disclosure relates to a shipping protector for protecting a radial shaft seal during shipping.

### BACKGROUND

This section provides background information related to the present disclosure which is not necessarily prior art.

With reference to FIG. 5, crankshaft seals 100 are commonly molded and then bonded or otherwise installed to a cover 102 such as a front or rear engine cover. The engine covers 102 can then be shipped to an engine assembly plant where they are assembled on an engine with the crankshaft seal 100 engaging a crankshaft of the engine. The sealing lip of the crankshaft seal is treated with a light grade oil. Contamination can adhere to the oil sealing surface. Accordingly, during shipping, it has been known to assemble a plastic shipping sleeve 104 on the engine cover 102 which is held in place by flexible fingers 106 in interference with a rim 108 of the stamped aluminum cover 102 that surrounds the crankshaft seal 100. The plastic shipping sleeve 104 is designed to protect the crankshaft seal 100 and prevent contamination from adhering to the oil on the sealing surface. At the engine assembly plant, the shipping sleeve 104 is removed prior to installing the engine cover 102 to the engine. While the use of the plastic shipping sleeves 104 has been effective at protecting the crankshaft seals 100 from contaminants, the plastic shipping sleeves 104 add a significant cost to the engine covers 102. According to at least one known example, the plastic shipping sleeves 104 add a cost of 0.16 USD each. With each engine requiring a front and a rear cover 102 with associated crankshaft seals 100, the plastic shipping sleeve 104 contribute an added cost of as much as 0.32 USD to each engine. In addition, the plastic shipping sleeves 104 require a significant amount of plastic to adequately secure the shipping sleeves 104 to the engine covers 102. Accordingly, it is desirable to provide a radial shaft seal shipping protector that reduces the cost and reduces the amount of material used.

### SUMMARY

This section provides a general summary of the disclosure, and is not a comprehensive disclosure of its full scope or all of its features.

An engine cover system, includes a metal engine cover having an opening that receives a radial shaft seal including a seal lip adapted to engage a shaft, and a plastic film adhered to the metal cover over top of the radial shaft seal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of an engine cover having a seal and a shipping protector for protecting the seal according to the principles of the present disclosure;

FIG. 2 is a cross sectional view of the engine cover taken along line 2-2 of FIG. 1;

FIG. 3 is a plan view of an alternative engine cover having a seal and a shipping protector for protecting the seal according to the principles of the present disclosure;

FIG. 4 is a cross sectional view of the engine cover taken along line 4-4-2 of FIG. 3; and

FIG. 5 is a perspective view of an engine cover having a seal and a shipping sleeve according to a conventional example.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

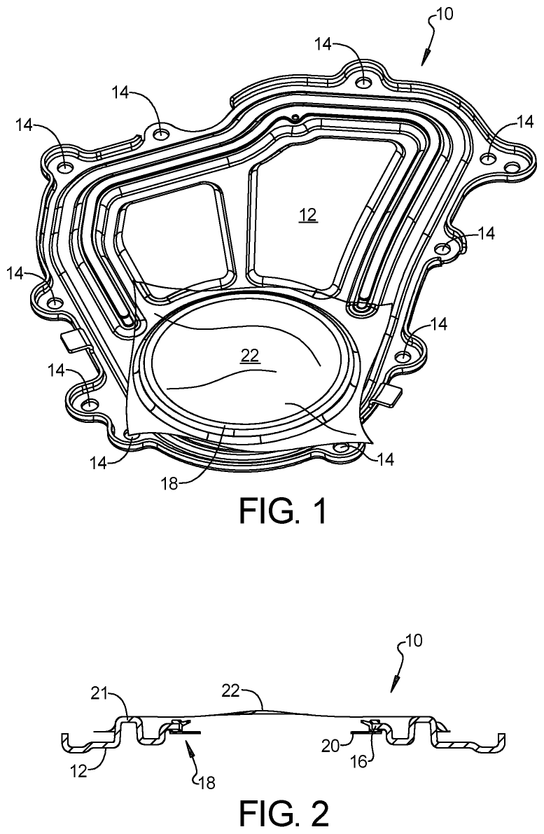

With reference to FIGS. 1 and 2, an engine cover assembly 10 is shown including a cover body 12 that can be stamped or otherwise made from aluminum, steel, plastic or other appropriate material. The cover body 12 can include a plurality of mounting apertures 14 and a seal aperture 16 for receiving a crankshaft seal 18 that can be bonded or otherwise secured in the aperture 16. The crankshaft seal 18 includes a seal lip 20 adapted to engage the crankshaft of an engine in a manner that is well known in the art. The sealing lip of the crankshaft seal is treated with a light grade oil. The cover body 12 includes a raised rim 21 surrounding the seal aperture 16. A plastic film 22 is adhered to the raised rim 21 of the cover body 12 over top of the aperture 16 and the crankshaft seal 18. The plastic film 22 can be a poly film and can include an adhesive pre-applied to one surface and the plastic films can be adhered to one or both sides of the cover body.

The engine cover assembly 10 can then be shipped to an engine assembly plant where it is assembled on an engine with the crankshaft seal 18 engaging a crankshaft of the engine. The plastic film 22 is designed to protect the crankshaft seal 18 and prevent contamination from adhering to the oil on the sealing surface. At the engine assembly plant, the plastic film 22 is removed prior to installing the engine cover assembly 10 to the engine. The use of the plastic film 22 provides a significantly less expensive alternative to the plastic shipping sleeves while utilizing less plastic to provide a greener solution. According to estimates, the plastic films 22 provide a cost reduction in comparison to the plastic shipping sleeves 104 of at least 0.14 USD each. These cost savings can add up to tens of thousands of dollars annually. The plastic film 22 can be pre-cut and/or perforated and is easily applied to the engine cover 12 by hand and does not require any heating.

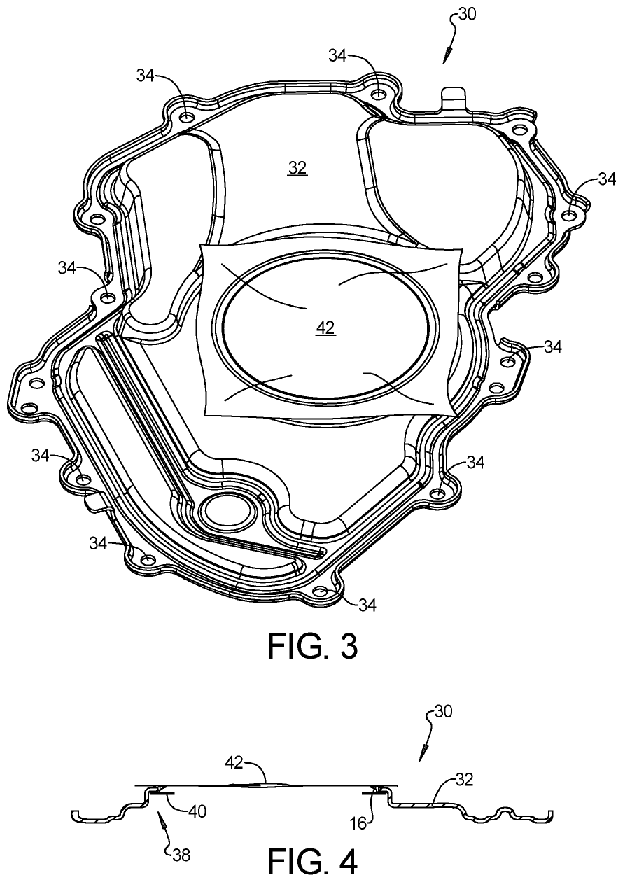

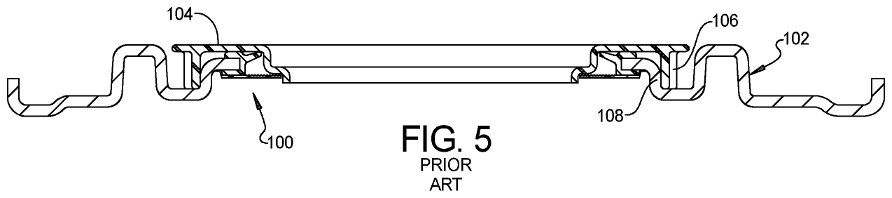

With reference to FIGS. 3 and 4, an engine cover assembly 30 according to an alternative embodiment is shown including a cover body 32 that can be stamped or otherwise made from aluminum, steel, plastic or other appropriate material. The cover body 32 can include a plurality of mounting apertures 34 and a seal aperture 36 for receiving a crankshaft seal 38 that can be bonded or otherwise secured in the aperture 36. The crankshaft seal 38 includes a seal lip 40 adapted to engage the crankshaft of an engine in a manner that is well known in the art. The sealing lip of the crankshaft seal is treated with a light grade oil. A plastic film 42 is adhered to the crankshaft seal 38. The plastic film 42 can be a poly film and can include an adhesive pre-applied to one surface and the plastic films can be adhered to one or both sides of the cover body.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An engine cover system, comprising:
a metal cover having a seal aperture that receives a radial shaft seal including a seal lip adapted to engage a shaft; and
a plastic film adhered over top of the radial shaft seal.

2. The engine cover system according to claim 1, wherein the plastic film is a poly film.

3. The engine cover system according to claim 1, wherein the plastic film includes adhesive on a surface thereof.

4. The engine cover system according to claim 3, wherein the plastic film is adhered to the radial shaft seal.

5. The engine cover system according to claim 3, wherein the plastic film is adhered to the metal cover.

6. The engine cover system according to claim 1, wherein the metal cover is stamped from aluminum.

7. The engine cover system according to claim 1, wherein the plastic film includes two plastic films applied on opposite sides of the metal cover.

8. The engine cover system according to claim 1, wherein the plastic film is adhered to the radial shaft seal.

9. The engine cover system according to claim 1, wherein the plastic film is adhered to the metal cover.

10. A method of preparing an engine cover for shipping, comprising:
stamping a metal cover to include a plurality of mounting apertures and a seal aperture;
mounting a radial shaft seal within the seal aperture of the metal cover; and
adhering a plastic film over top of the radial shaft seal and the seal aperture.

11. The method according to claim 10, wherein the plastic film is a poly film.

12. The method according to claim 10, wherein the plastic film includes adhesive on a surface thereof.

13. The method according to claim 10, wherein the plastic film is adhered to the radial shaft seal.

14. The method according to claim 10, wherein the plastic film is adhered to the metal cover.

15. The method according to claim 10, wherein the metal cover is stamped from aluminum.

16. The method according to claim 10, wherein the plastic film includes two plastic films applied on opposite sides of the metal cover.
